(19) United States
(12) Patent Application Publication
(10) Pub. No.: US 2011/0315269 A1
(43) Pub. Date: Dec. 29, 2011

(54) HIGH WORKLOAD INJECTION SYSTEM

(75) Inventors: DANIEL E. WILLIAMSON, Sherwood, OR (US); JOHN R. MARSHALL, Beaverton, OR (US)

(73) Assignee: BIOJECT, INC., Tualatin, OR (US)

(21) Appl. No.: 12/824,088

(22) Filed: Jun. 25, 2010

(51) Int. Cl. B65B 3/12; B67D 7/60

(52) U.S. Cl. 141/2; 141/181

(57) ABSTRACT

A filling device for a needle-free injector system is provided that is adapted to sterilely deliver a predetermined amount of an injectate from a vial to a plurality of cartridges. The filling device normally includes a single-use fluid path disposed between the vial and a receiving cartridge. The fluid path may include a vial connector adapted to couple to a vial, a filler head, and a conduit connecting the vial connector and filler head. The filling device typically further includes a pump coupled to the fluid path and adapted to propel the injectate from the vial to the receiving cartridge, and a cartridge-advancing element. Activation of the cartridge-advancing element is adapted to sequentially advance empty cartridges into a position opposite the filler head. Also provided are disposable fluid path kits and methods of using the filling device.

### TECHNICAL FIELD

Embodiments herein relate to the field of injections, for instance needle-free injections, and more specifically, to methods and apparatus for providing high throughput injections.

### BACKGROUND

It is often desirable to deliver inoculations, medications, or other injectable substances to a large number of recipients. For example, it has been shown that vaccinations are an effective method for reducing and/or eliminating the spread of communicable diseases. However, the delivery of injections to large numbers of people presents several problems, including expense, difficulty of transportation, cross-contamination between recipients, and the creation of hazardous biowaste. These problems can be compounded in economically deprived areas where resources may be limited.

Current methods for delivering vaccinations to populations of recipients typically use needled syringes. These methods typically require filling of the syringes and disposal of the needle and syringe after each use. Even in the hands of the most careful users, accidental needle sticks, and the accompanying concerns about cross-contamination, take place.

Needle-free injection systems allow a faster immunization process than needled syringes and eliminate the possibility of accidental needle sticks. However, in order to facilitate large-scale vaccination programs and other uses, a filling device is necessary to sterilely transfer injectate from a reservoir or other source vessel into fluid injection assemblies (for instance, cartridges) that are used in the injection system. Such filling devices represent a source of potential contamination, however, particularly when used in non-sterile field environments. Careful cleaning of the device and associated components is required, as is a power source to operate the device.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 is a schematic, front perspective view of a filling device, in accordance with various embodiments;

FIGS. 2A and 2B are schematic, sectional views of a portion of a filling device before (2A) and after (2B) a cartridge is filled, in accordance with various embodiments;

FIGS. 3A and 3B are schematic, close-up sectional views of a cartridge assembly in a filling device before (2A) and after (2B) a cartridge is filled, in accordance with various embodiments;

FIG. 4 is a schematic, rear perspective view of a filling device; and

FIG. 5 is a schematic, close-up elevational view of a hand crank and gears that may be used for advancing a cartridge assembly through a filling device, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized, and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

In various embodiments, needle-free injector methods, apparatuses, and systems are provided. In exemplary embodiments, a computing system may be endowed with one or more components of the disclosed apparatuses and/or systems and may be employed to perform one or more methods as disclosed herein.

Embodiments herein provide methods, systems, and apparatuses for high-throughput injections, such as needle-free injector systems. Needle-free injector systems, such as those disclosed in U.S. Pat. No. 6,935,384, which is incorporated by reference herein in its entirety, as well as those disclosed in U.S. Pat. Nos. 4,941,880; 5,064,413; 5,312,335; 5,383,851; 5,399,163; 5,520,639; 5,993,412; 6,096,002; 6,264,629; 6,383,168; 6,471,669; are effective, for instance, for mass vaccination programs, particularly in remote areas, for biodefense applications, such as field delivery of antidotes and vaccines, and for other applications requiring rapid and/or large-scale injection programs with little or no risk of cross-contamination and a low cost per injection. In various embodiments, it is desirable to be able to field-load the needle-free injector system with a desired injectate, for instance, in response to disease outbreaks or other changing conditions.

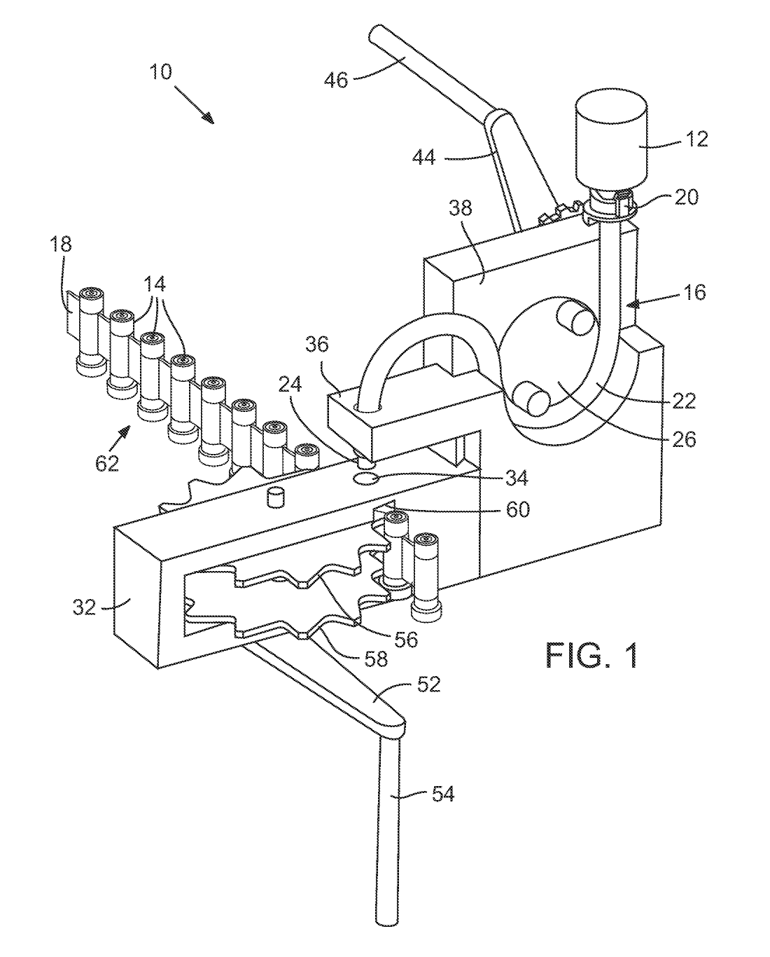

Thus, provided in various embodiments is a filling device for a needle-free injector system. In various embodiments, the filling device may be used to fill one or more fluid ejection assemblies, such as cartridges, with an injectable fluid. The cartridges then may be loaded into a needle-free injector for administration to one or more subjects. An embodiment of such a filling device is illustrated in FIG. 1. In various embodiments, the filling device 10 may be adapted to sterilely transfer a predetermined amount of injectate 26 directly from a vessel 12, such as a drug vial, to a plurality of fluid ejection assemblies or cartridges 14 via a fluid path 16. A carrier 18 may hold or otherwise join two or more cartridges 14 together. In various embodiments, all components of filling device 10 that come into contact with the injectate 26 may be disposable (e.g., single-use, such that they are thrown away after a single use, for instance after a single filling session, or after a given period of time, such as a day, or for a certain number of uses, such as for 100 cartridge fillings, and then disposed of). For instance, the entire fluid path 16, which may include, for instance, vial connector 20, a conduit such as a tube 22, and filler head 24, may be disposable. Such disposable components may virtually eliminate the risk of contamination of the injectate or cartridges 14, even in highly contaminated environments, such as may be found in field use.

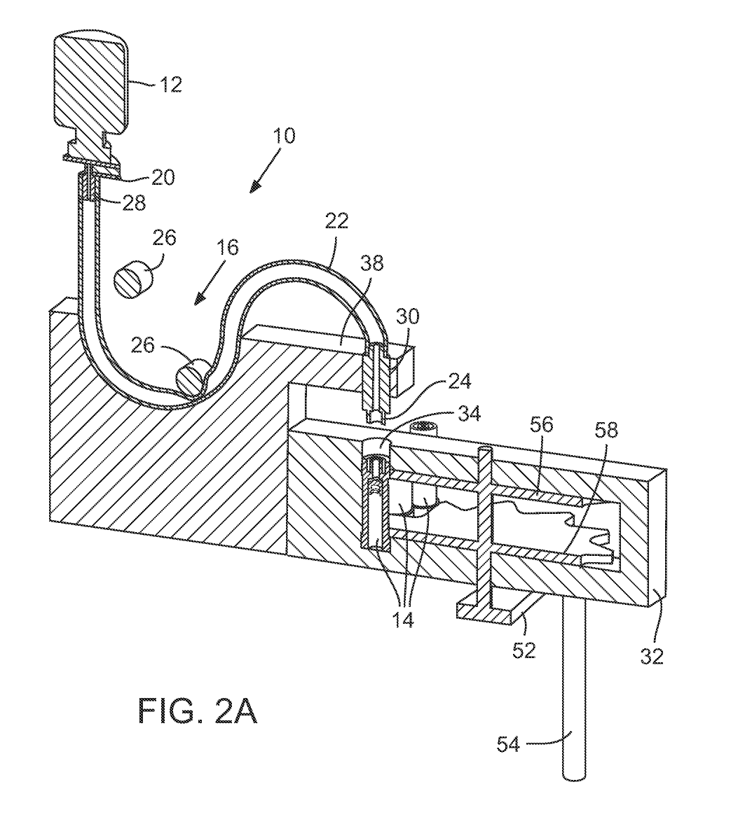

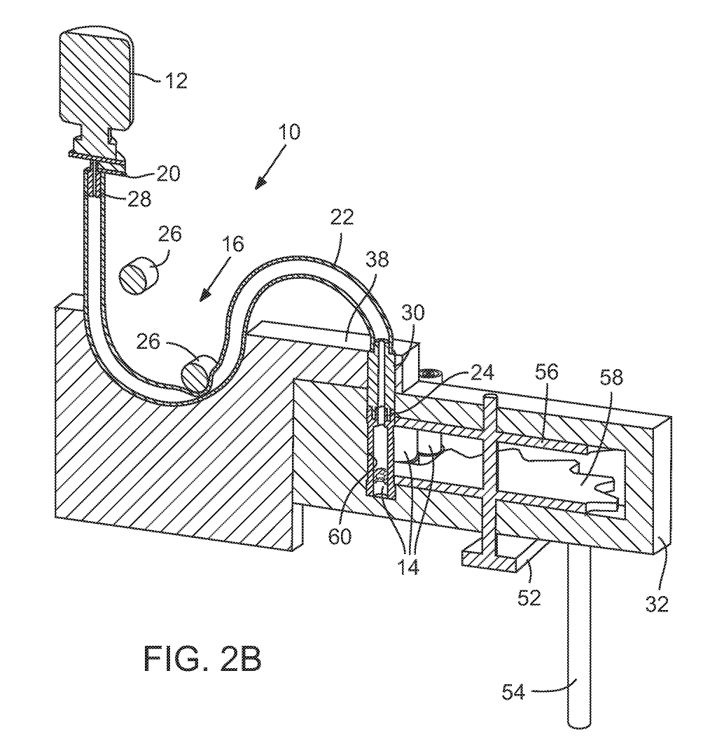

An exemplary high throughput needle-free injection system filling device 10 is shown in a cross-sectional view in FIGS. 2A and 2B. As shown, filling device 10 may be adapted to sterilely transfer a predetermined amount of injectate 26 from a vessel or vial 12, which in this embodiment takes the form of a drug vial, to a plurality of cartridges 14, which in this embodiment take the form of disposable cartridges. In the illustrated example, vial connector 20 may connect vial 12 to tube 22 via a spike connector 28. In some embodiments, spike connector 28 may be an integral part of the disposable vial connector 20, which may help ensure a low risk of contamination. One of skill in the art will appreciate that this configuration may permit injectate 26 to be passed directly from the original product packaging (e.g., vial 12) to cartridges 14 without any intermediate step of loading the injectate into a syringe or other carrier for transfer. In various embodiments, this may reduce the number of steps required for the operation, while also reducing waste and potential contamination opportunities.

In some embodiments, an additional step may be added, for instance in order to dilute a drug concentrate or reconstitute a lyophilized drug or vaccine preparation before it is transferred to a cartridge. In this embodiment, a second filling device may be used to prepare the injectate. For instance, instead of delivering the injectate to a cartridge, the second filling device may first deliver a feed diluant (e.g., water, saline, PBS, Ringer's solution, or the like) into a vial containing the lyopholized or concentrated drug formulation, thus reconstituting or diluting the drug to an appropriate concentration. The reconstituted or diluted drug vial could then be used by another filling device to transfer the vial contents into one or more cartridges.

As shown in this embodiment, a peristaltic pump 27 housed in a pump housing 38 may be used to pump injectate 26 from vessel 12, though vial connector 20, tube 22, and filler head 24, and into cartridge 14. Although peristaltic pump 27 is illustrated in this embodiment, it will be understood by those skilled in the art that any type of pump or air pressure system may be substituted for peristaltic pump 27. For instance, in a hospital or other setting where a source of compressed air may be available, an air pump may be used to pump injectate 26 through fluid path 16. In the illustrated embodiment, each stroke of the peristaltic pump may pass a predetermined amount of injectate 26 through fluid path 16. For instance, in some embodiments, this volume may correspond to the volume of injectate 26 that fills a single cartridge 14. The illustrated embodiment shows a bolus 30 of injectate 26 filling the far end of tube 22 and filler head 24. Also illustrated is a single cartridge 14, which may pass through a cartridge carriage 32 during the filling procedure. It is desirable that the connection between the filler head 24 and the cartridge 14 be a fluid tight seal such as a that provided by a Luer fitting or a seal with a resilient gasket against a flat surface. A check valve, such as a duck bill valve (not shown), is also often included to prevent backflow of injectate 26 through the fluid path.

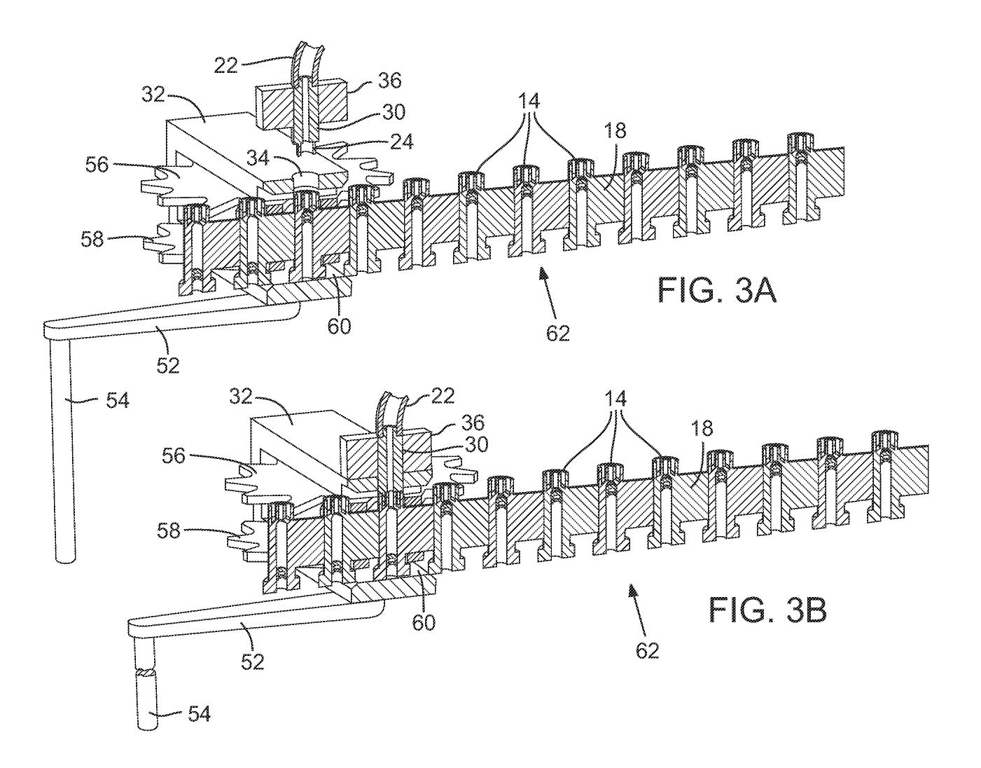

FIGS. 3A and 3B are close-up cross-sectional views of cartridges 14 and cartridge carrier 18 as they pass through the cartridge carriage 32 before (3A) and after (3B) the filling process. As shown, the distal end of tube 22 may be coupled to the cartridge carriage 32 (which may be coupled to the housing 38), and may couple to a filler head 24 that may be positioned directly above cartridge 14 that is to be filled. In many embodiments, injectate bolus 30 may forced from filler head 24 into cartridge 14 by positive air pressure or by a peristaltic pump, for instance. In some embodiments, an air-purge of cartridge 14 may occur as part of the filling process to eliminate air or other gas bubbles. This purge may be accomplished utilizing a plunger system (not shown) as part of the cartridge assembly. In an initial position, the plunger would be virtually bottomed out such that injectate filling the cartridge would force the plunger back until the cartridge is filled or even slightly over-filled. Then the plunger could be forced down slightly such as by a push rod or air pressure to force any gas back into the vial 12 or through a vent or bypass line (again, not shown). A vibratory system (not shown) may also be included to ensure that most if not all of the entrained gas rises to the top of the injectate to facilitate removal thereof. In a typical embodiment, cartridges 14 each include an orifice at one end with a plunger mounted at the other end, the plunger having a rod extending outwardly therefrom to control the position of the plunger.

It should be appreciated that it may be desirable for cartridge 14 to be a single-use or disposable cartridge that, once spent, cannot be reused. Consequently, in some examples, once cartridges 14 are detached from the cartridge carrier 18, they may not be fed back into the filling device. For example, the cartridges may be molded in groups of 10, 12, 14 or more, either independently or as part of the cartridge carrier 18. When used, cartridges 14 are broken off and thus may not be re-attached or re-mounted to the cartridge carrier 18. Alternatively or additionally, a system to prevent cartridges 14 from being re-filled might be provided. U.S. Patent Application 2010/0076374 is incorporated herein by reference, and includes an auto-disabled plunger that includes a frangible section to provide additional protection so the cartridge cannot be re-used. Although the illustrated cartridge carrier 18 is shown in a vertical orientation relative to cartridges 14, one of skill in the art that any number of other types of carriers or racks may be substituted, and that these may be oriented in any direction relative to cartridges 14.

Two systems that may be used to prevent reuse of the cartridges are known as the B-2000 device and the Zetajet system. The B-2000 device has a proprietary nozzle attachment system consisting of three lugs on the nozzle that fit through three matching cutouts in the front cover of the B-2000 device. In embodiments, the nozzle may lock into place by inserting the nozzle into the device through the three cutouts, then rotating the nozzle approximately 60° where it bears on the front cover between the cutouts. There is a spring loaded detent within the device that provides feedback to the user when the nozzle is in its final locked position.

In various embodiments, the plunger for the B-2000 nozzle protrudes from the nozzle, but does not contact any portion of the B-2000 when the nozzle and plunger is inserted into the B-2000 device. In some embodiments, the B-2000 also may have an auto-disable feature. When the B-2000 is fired, grippers within the B-2000 that are arranged radially around the plunger may grab the protruding portion of the plunger then force the plunger forward throughout the injection sequence.

The Zetajet device has a proprietary nozzle attachment system consisting of two lugs on the nozzle that fit through two matching cutouts in the front cover of the Zetajet device. The nozzle locks into place by inserting the nozzle into the device with the lugs oriented to fit through the two cutouts, then rotating the nozzle 90° where it bears on the front cover between the cutouts. In embodiments, there is a spring-loaded component within the device that both locks the nozzle into place and provides feedback to the user when the nozzle is in its final locked position.

In embodiments, the Zetajet nozzle may have a plunger tip that is set in place within the nozzle. In some examples, it is set into its final position when the nozzle is filled. The Zetajet device has a ram component in contact with the power spring that comes into close contact with the plunger tip when the nozzle is inserted. When the device is triggered, the ram is driven forward, pushing on the plunger tip driving the fluid out of the nozzle.

It will be appreciated that in the embodiments described above, the entire fluid path 16 consists of drug vial 12; vial connector 20, which may include spike connector 28 (for puncturing the seal on vial 12); tube 22; filler head 24; and cartridge 14. Thus, any injectate introduced into the system may make contact only with vial connector 20, tube 22, filler head 24, and cartridge 14. It will further be appreciated that each of these components may be disposable. In some embodiments, vial connector 20, tube 22, filler head 24, and cartridge 14 may be “single use,” e.g., used once (for instance, for a single filling session) and then thrown away. Such a single session might be defined as a given period of time, for example, several hours, half a day, or a day before the fluid path components are disposed of. Alternatively the fluid path components may be used to fill a certain number of cartridges, for example, 50, 100, or 500 and then disposed of. In particular examples, the components that make up fluid path 16 may be packaged in a single disposable sterile pouch or kit for installation on the filler device 10 before a given filling session begins. In some embodiments, vials 12 of injectate 26 may be swapped out during the filling process as needed without disrupting the filling process. That is, a first vial that has been emptied might be removed and replaced with a full vial. Air or other gas may be removed from the system by the process described above, or the direction of the pump may even be reversed. The system may accommodate any size and/or shape of vial 12, for instance 5 ml, 20 ml, or 100 ml vials 12. It also will be appreciated that some materials are more useful for disposable components than others. For example, plastics, which are lightweight and inexpensive, tend to be suitable for disposable applications.

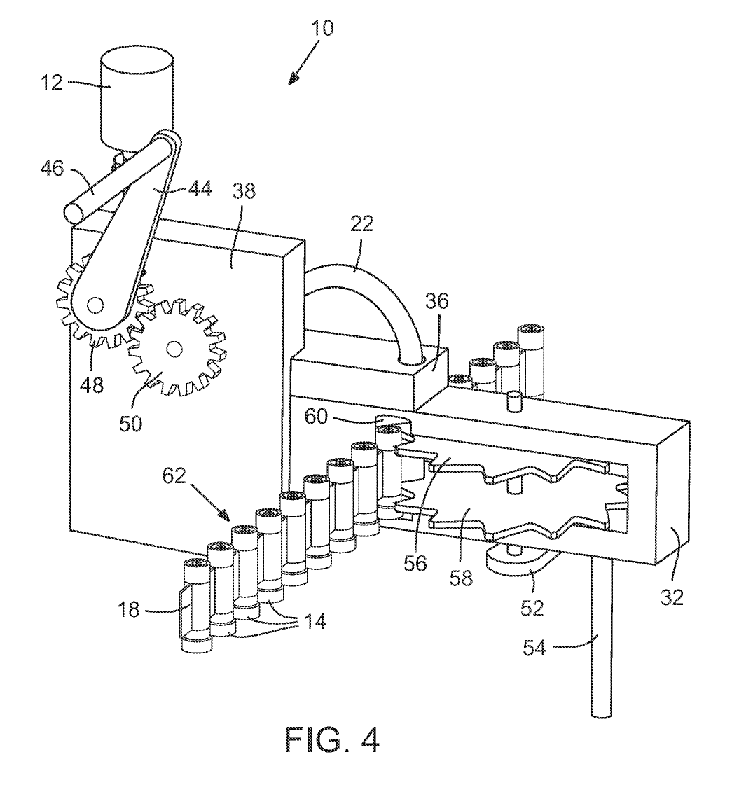

FIG. 4 depicts a rear elevational view of filling device 10. Typically, peristaltic pump 27 of filling device 10 may include a power generator to control operation of the device. It will be appreciated that the power generator may be a user (with a crank), a motor, or other mechanism. For example, as illustrated in the embodiment shown in FIG. 4, rotation of peristaltic pump 27 may be controlled and powered by rotation of shaft 42. Rotation of shaft 42 may be electronic, motor-driven, hand-driven, or the like. If rotation of shaft 42 is hand-driven, for instance, filling station 10 may include a hand crank 44 and handle 46 (both of which are also shown in FIG. 1). In the depicted embodiment, movement of hand crank 44 may engage and thus rotate shaft 42, which may engage and rotate gear 48, which, in turn, may engage and rotate gear 50, which then may engage and rotate shaft 52, which may then actuate the peristaltic pump 26. Thus, in this embodiment, the power generator may include a user operating a hand crank 44. In some examples, a single rotation of hand crank 44 may power the peristaltic pump to fill a single cartridge 14, while in other embodiments, a half-turn or quarter turn of crank 44 may provide sufficient power to the peristaltic pump to fill a single cartridge 14. One of skill in the art will appreciate that such hand crank ratios may be adjusted by varying the gear ratio of gears 48 and/or 50.

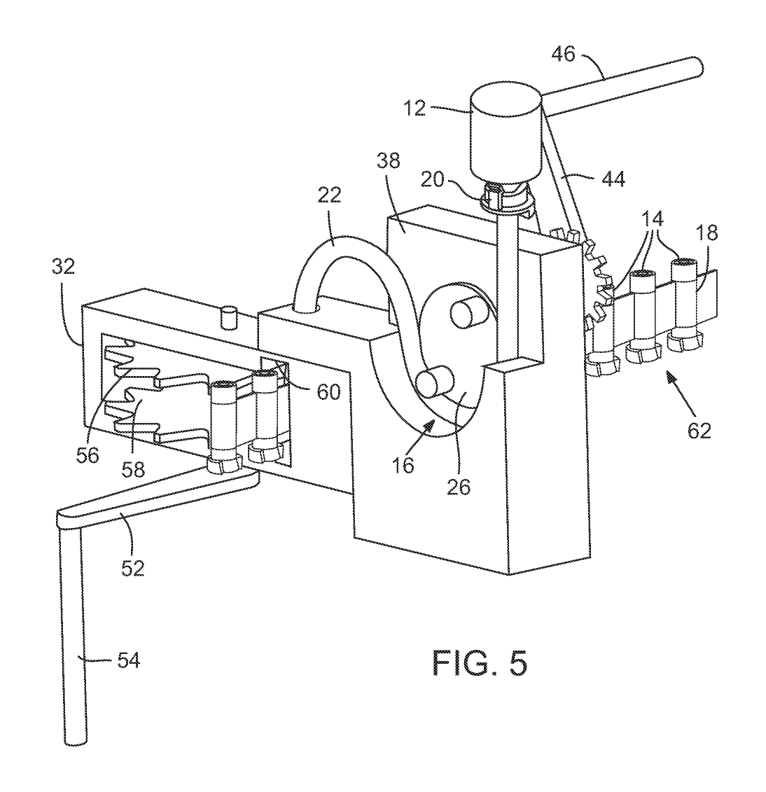

FIG. 5 is a close-up elevational view of hand crank 52, handle 54, and gears 56, 58 that may be used in some embodiments for advancing cartridge carrier 18 and cartridges 14 through filling device 10. It may be seen that multiple cartridges 14 may be joined by cartridge carrier 18, forming cartridge assembly 62. In various embodiments, rotation of hand crank 52 may cause gears 56, 58 to engage cartridges 14 and to advance cartridge assembly 62 through cartridge carriage 32. In the embodiment shown, cartridge assembly 62 may be fed through filling device 10 via opening 60 in cartridge carriage 32.

In various embodiments (not shown), cartridge assembly 62 may be formed of plastic, and each cartridge 14 may be joined to cartridge carrier 18 by one or more sprues. Thus, the entire cartridge assembly 62, including cartridges 14, may be molded as a single piece in some embodiments. Alternatively, cartridges 14 may be formed separately and then joined to carriage 18 using any suitable means. In some embodiments, cartridge 14 may be released from cartridge carrier 18 by breaking the sprues away from cartridge 14. In particular embodiments, filling device 10 may be adapted to receive and fill only cartridges that are part of cartridge assembly 62. As such, in some embodiments, once a cartridge 14 is broken away from cartridge carrier 18, it may not be refilled. Of course, it will be appreciated that a filling station also may be adapted to receive single cartridges 14 or cartridge carriers 18 having different configurations from those shown.

Also disclosed herein are methods of filling a needle-free injector system cartridge with an injectate. These methods may include, in some embodiments, installing a disposable feed system (for instance, a vial spike, hose, and filler head) in a filling device, inserting a cartridge assembly (e.g., cartridges, cartridge carrier) into an aperture in the filler device, attaching a vaccine or drug vial to the proximal end of the disposable feed system, priming the system, and using one or more hand cranks to power the system. In some embodiments, the method also may include replacing empty vials with new vials as needed during the filling process.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A filling device for a needle-free injector system, the filling device adapted to sterilely deliver a predetermined amount of an injectate from a vial to a plurality of cartridges, the filling device comprising:
a fluid path disposed between the vial and a receiving cartridge, wherein the fluid path is designed to be single-use, the fluid path comprising:
a vial connector adapted to couple to a vial;
a conduit having a first end and a second end; and
a filler head, wherein the vial connector is coupled to the first end of the conduit, and wherein the filler head is adapted to couple to the second end of the conduit;
a pump coupled to the fluid path and adapted to propel the injectate from the vial to the receiving cartridge; and
a cartridge-advancing element, wherein activation of the cartridge-advancing element is adapted to sequentially advance empty cartridges into a position opposite the filler head.

2. The filling device of claim 1, wherein the pump and the cartridge-advancing element are both manually operable.

3. The filling device of claim 2, wherein the manually-operable pump and cartridge-advancing element are operable by hand crank.

4. The filling device of claim 1, wherein the pump is a peristaltic pump or a positive displacement pump.

5. The filling device of claim 1, wherein the cartridges are coupled to one another by a cartridge carrier device.

6. The filling device of claim 5, wherein the filling device has a housing that is adapted to receive the cartridge carrier device.

7. The filling device of claim 6, wherein passing the cartridge carrier device through the housing decouples the cartridges from the cartridge carrier device, and wherein decoupling the cartridges from the cartridge carrier device renders the cartridges unable to pass through the housing a second time.

8. The filling device of claim 1, wherein the fluid path is disposable.

9. The filling device of claim 1, wherein the vial adapter comprises an air conduit, and wherein the air conduit is adapted to provide a route of air ingress that prevents the formation of a vacuum when injectate is withdrawn from the vial.

10. The filling device of claim 9, wherein the route of air ingress is pressurized,

11. The filling device of claim 1, wherein the cartridges comprise syringes.

12. The filling device of claim 1, wherein the filling device comprises one or more valves.

13. The filling device of claim 1, wherein the filling device is adapted to be folded into a compact storage configuration.

14. The filling device of claim 1, wherein the cartridges are disposable.

15. The filling device of claim 1, wherein the vial connector is adapted to couple to any size of vial.

16. The filling device of claim 1, wherein the vial may be replaced during use without interrupting the filling process.

17. The filling device of claim 1, wherein the cartridges are adapted to prevent re-use.

18. The filling device of claim 17, wherein the cartridges comprise Zetajet cartridges or B-2000 cartridges.

19. The filling device of claim 1, wherein the fluid path is adapted to prevent re-use.

20. A disposable fluid path kit for use in a needle-free injector filling device, wherein the disposable fluid path kit is adapted to prevent re-use and comprises:
a tube having a first end and a second end;
a vial connector adapted to couple a vial to a first end of the tube;
a filler head adapted to couple to the second end of the tube, wherein the disposable fluid path kit is adapted to sterilely fill a cartridge with the fluid contents of the vial.

21. A method of using a needle-free injector filling device comprising:
installing a disposable fluid path kit in the filling device, wherein the disposable fluid path kit is adapted to prevent re-use, and wherein the disposable fluid path kit comprises a vial connector coupled to a first end of a tube, and a filling head coupled to a second end of the tube;
installing a plurality of cartridges in the filling device;
coupling a vial to the vial connector, wherein the vial comprises an injectable fluid; and
using a hand crank to activate a pump, wherein the pump propels the injectable fluid out of the vial and into the plurality of cartridges.
